(19) United States
(12) Patent Application Publication
(10) Pub. No.: US 2003/0156980 A1
(43) Pub. Date: Aug. 21, 2003

(54) Methods for disinfecting and cleaning dental root canals using a viscous sodium hypochlorite composition

(76) Inventors: Dan E. Fischer, Sandy, UT (US); Peter M. Allred, Riverton, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/050,664

(22) Filed: Jan. 16, 2002

(51) Int. Cl. A61C 5/02

(52) U.S. Cl. 422/37; 433/32; 422/224

(57) ABSTRACT

A viscous disinfectant comprising sodium hypochlorite, water, and a thickening agent (e.g., fumed silica) is used to disinfect and sanitize a root canal during an endodontic procedure. The viscosity of the disinfectant enables the disinfectant to adhere to the walls of the root canal so that the sodium hypochlorite can disinfect and sanitize the walls of the root canal in a desired and controlled manner. The root canal is accessed and cleaned with endodontic tools, during which pulp is removed from the root canal. The viscous disinfectant is introduced into the root canal and adheres to the walls of the root canal until it is removed. While in the root canal, the viscous disinfectant disinfects and sanitizes the root canal so that it can be filled and sealed according to endodontic procedure.

### BACKGROUND OF THE INVENTION

1. The Field of the Invention

The present invention relates to the field of endodontics. More particularly, the present invention relates to methods and compositions for disinfecting a dental root canal during endondontic procedures.

2. The Prior State of the Art

Endodontics is the branch of dentistry that generally deals with infections and diseases of dental pulp. Dental pulp, which is found in the pulp chamber and root canals of the tooth, comprises a vascular tissue that is generally composed of nerve fibers and blood vessels that nourish the tooth during its growth and development. When bacteria gains access to the pulp, either through a fractured tooth or a deep cavity, the pulp can become infected and will die unless the body is able to repair and heal the pulp. Pulp can also become infected when the tooth suffers from trauma or a periodontal disease.

A tooth with infected or damaged pulp is often sensitive to changes in temperature and pressure, and may become discolored. The gingivae surrounding the tooth may also experience swelling and sensitivity. The body will attempt to heal any infected or damaged pulp. However, when the pulp becomes so severely infected or otherwise damaged that it cannot be healed, it is necessary to remove the pulp to relieve the pain and to prevent the infection from spreading outside of the tooth. Pulp can either be removed by extracting the tooth or by performing an endodontic procedure, such as a root canal.

During a root canal, the endodontist first drills through the crown of the tooth to access the pulp chamber and root canal. Then the endodontist cleans and shapes the root canal with endodontic tools that generally loosen the contaminated pulp and widen the root canal so that it can be filled with a filling material. During the endodontic procedure, irrigants are used to flush the pulp tissue out of the root canal and disinfectants are used to kill the bacteria inside of the root canal. The final step of performing the root canal procedure, which is also known as obturation, involves filling the root canal with a filling material such as gutta percha or amalgam and sealing the filling with a sealer cement to prevent future contamination of the root canal.

One problem with existing methods for performing endodontic procedures, however, is that the structural anatomy of the tooth makes it difficult to completely eradicate all of the bacteria within the root canal. In particular, the root canal comprises irregular accessory canals and microscopic tubules where bacteria can lodge and fester. It is estimated that each tooth contains approximately 1.5 million microscopic tubules. Typically, the body's immune system is able to contain and neutralize the minimal amount of bacteria that becomes trapped inside of the accessory canals and microscopic tubules. However, in limited circumstances, trapped bacteria are able to multiply and create toxins that can result in future complications and infections.

According to one theory, known as the “focal infection theory,” toxins produced by bacteria trapped in the teeth are eventually transmitted through the blood, nerve, and lymph systems to other parts of the body, including vital organs, where they can cause severe illness. The focal infection theory is not universally accepted, however, and has been under debate since the early 1900's. Nevertheless, it is still desirable to sanitize the root canal as completely as possible during the endodontic procedure so as to increase the likelihood that the endodontic procedure will be successful. It is estimated that approximately 10% of all root canals are unsuccessful for one reason or another, including improper sanitation the root canal. Accordingly, by better sanitizing the root canal, it is possible to increase the likelihood that the endodontic procedure will be successful.

Antibacterial disinfectants currently exist and are used during endodontic procedures to sanitize the root canal. However, the known endodontic disinfectants are provided in liquid form, presumably to facilitate penetration into the accessory canals and tubules. Nevertheless, existing disinfectants and irrigants have proven ineffective in eradicating all bacteria in about 10% of all root canal procedures.

Existing disinfectants have also proven to be problematic when the root canal is in an upper tooth because gravity can cause the disinfectant to flow out of the root canal. This is not only inconvenient, but it can also be harmful to the patient, particularly if caustic and irritating to sensitive oral tissues. To overcome such problems, many endodontists employ a rubber dam barrier to minimize the likelihood that the disinfectant will flow onto surrounding oral tissues. Nevertheless, rubber dam barriers are not totally effective in controlling the potential outflow of disinfectant and irritation of surrounding oral tissues.

Accordingly, there is currently a need in the art for improved methods for disinfecting and sanitizing root canals during endodontic procedures with a disinfectant that is able to disinfect the root canal and remain in place during the intended treatment.

### SUMMARY OF THE INVENTION

The present invention is directed to improved methods for disinfecting and sanitizing root canals during endodontic procedures using a viscous disinfecting composition that is able to better adhere to the walls of the root canal. More particularly, the present invention is directed to methods for using viscous disinfecting sodium hypochlorite compositions to disinfect and sanitize root canals during endodontic procedures.

According to one presently preferred embodiment, the disinfecting compositions of the invention comprise a disinfectant, water, and a thickener or gelling agent. The disinfectant comprises an aqueous sodium hypochlorite solution and the gelling agent comprises at least one of a particulate thickening agent (e.g., fumed silica, such as Aerosil or Cabosil M-5) or a polymeric thickening agent (e.g., carboxypolymethylene, such as CARBOPOL). The gelling agent increases the viscosity of the compositions, which generally enables the compositions to better adhere to the surfaces of the root canal, and thereby enables the sodium hypochlorite to maximize its ability to disinfect and sanitize the root canal. The viscous properties of the disinfecting compositions generally enable the compositions to be applied in a more controlled manner than is possible using existing low viscosity disinfecting compositions. For example, a thicker layer and, hence, more of the sodium hypochlorite solution, can be applied to a given surface area compared to runny, non-viscous solutions that can more easily run off the surface to which it is applied.

The present invention provides methods for using viscous disinfecting compositions during endodontic procedures. According to one preferred embodiment, access is provided to a root canal of a tooth. The root canal is cleaned and shaped using endodontic tools. During this step, pulp is removed from the root canal and a viscous disinfecting composition of the invention is introduced into the root canal. The viscous disinfecting composition adheres to the walls of the root canal and generally disinfects the root canal, while chelating pulp particles that remain in the root canal. At any time during the procedure, an irrigant may be used to remove the viscous disinfectant and loosened pulp from the root canal.

The methods of the invention generally provide for viscous sodium hypochlorite disinfectants to be introduced into a root canal and to be applied to the surfaces of the root canal, to which they adhere. It should be appreciated that the viscosity of the disinfecting compositions of the invention generally enables the sodium hypochlorite to be placed in contact with the surfaces of the root canal for a sufficient period of time, so as to disinfect and sanitize the root canals, accessory canals and microscopic tubules. It should also be appreciated that this is an advance over the prior art in which existing disinfectants are applied in a non-viscous form and in which the existing disinfectants do not adhere as well to the walls of the root canal. It should further be appreciated that the viscosity of the disinfecting compositions of the invention generally enables sodium hypochlorite compositions to be applied to the root canal in a controlled manner.

These and other features and advantages of the present invention will become more fully apparent from the following description and appended claims, or may be learned by practicing the invention as set forth below.

### BRIEF DESCRIPTION OF THE DRAWINGS

A more extensive description of the present invention, including the above-recited features and advantages, will be rendered with reference to the specific embodiments that are illustrated in the appended drawings. Because these drawings depict only exemplary embodiments, the drawings should not be construed as imposing any limitation on the present invention's scope. As such, the present invention will be described and explained with additional specificity and detail through use of the accompanying drawings in which:

FIG. 1 is a cross-sectional side view of a tooth that illustrates various elements of the tooth, including the crown, dentin, roots, root canals, pulp chamber, and pulp;

FIG. 2 is a cross-sectional side view of the tooth of FIG. 1 that shows a drilling burr drilling a hole through the crown and dentin of the tooth into the pulp chamber;

FIG. 3 is a cross-sectional side view of the tooth of FIG. 1 that illustrates the use of an abrading endodontic tool to clean out the pulp and other soft tissue within a root canal;

FIG. 4 is a cross-sectional side view of a dental root with an endodontic tool inserted inside of a root canal, with a viscous disinfecting composition of the invention adhering to the walls of the root canal, and with pulp particles residing on portions of the root canal walls and within accessory canals;

FIG. 5 is a cross-sectional side view of the dental root of FIG. 4 in which the endodontic tool has been removed and in which the viscous disinfecting composition continues to adhere to the walls of the root canal with pulp particles floating in the viscous disinfecting composition;

FIG. 6 is a cross-sectional side view of the tooth of FIG. 1 that has been sanitized and disinfected using a viscous disinfecting composition of the invention; and

FIG. 7 is a flow diagram that illustrates one presently preferred method for using the viscous disinfecting composition of the invention to disinfect a root canal during an endodontic procedure.

### DETAILED DESCRIPTION OF THE PREFERRED EMBODIMENTS

The present invention relates to methods for using viscous disinfecting compositions during endodontic procedures to disinfect and sanitize root canals.

The terms “disinfect” and “sanitize” generally refer to killing, chelating or otherwise destroying bacteria. However, as used herein, the terms “disinfecting” and “sanitizing” can also be broadly construed to include chelating pulp and other substances residing in the root canal.

The term “non-viscous” is generally defined herein as free flowing and having a water-like consistency.

The term “viscous” is generally defined herein as thicker and less free flowing than water and having a consistency that allows it to better adhere to dental tissue.

1. Viscous Disinfecting Compositions

The disinfecting compositions of the invention comprise a disinfectant, water, and a gelling or thickening agent. According to one presently preferred embodiment, the disinfectant of the invention comprises an aqueous disinfectant solution of sodium hypochlorite. Sodium hypochlorite is well known in the art as a chlorine disinfectant and is generally produced by mixing chlorine (Cl₂), water (H₂O) and sodium hydroxide (NaOH), which cause the chlorine to dissociate into sodium hypochlorite (NaOCl) and sodium chloride (NaCl).

The sodium hypochlorite may be included in any acceptable amount that is efficacious for disinfecting and sanitizing a root canal. For example, the sodium hypochlorite may be included in a broad range of about 0.01% to about 50% by weight of the composition, preferably in a range of about 0.1% to about 40%, more preferably in a range of about 1% to about 20% by weight, and most preferably in a range of about 2% to about 10% by weight. In one embodiment, the sodium hypochlorite is provided as a 5% solution in water, and then mixed with additional water and one or more thickening agents.

The sodium hypochlorite is mixed with water and a gelling agent to provide the compositions having a desirable concentration and viscosity. According to one presently preferred embodiment, the disinfecting compositions of the invention preferably have a viscosity in a range of about 500 cps to about 200,000 cps, more preferably in a range of about 5,000 cps to about 100,000 cps, and most preferably in a range of about 10,000 cps to about 50,000 cps. Although the exemplary compositions below were not tested for viscosity, the aforementioned ranges were estimated by comparing the exemplary compositions to known Brookfield viscometer liquid standards and then extrapolating to obtain the preferred ranges.

To provide the desired viscosity, the disinfecting compositions of the invention comprise at least one thickening agent, examples of which include finely divided particulate thickening or gelling agents and polymeric thickening agents. Examples of particulate thickening agents include, but are not limited to, fumed silica and fumed aluminum oxide. Examples of suitable fumed silica gelling agents include, but are not limited to, Aerosil and Cabosil M-5. A preferred polymeric thickening agent is carboxypolymethylene, an example of which is Carbopol, e.g., Carbopol 974.

The thickening or gelling agents may be included in any amount that increases the viscosity and adhesion of the composition relative to runny, non-viscous compositions. The thickening or gelling agents are preferably included in a range of about 0.1% to about 30% by weight of the disinfecting composition, more preferably in a range of about 0.5% to about 20% by weight, and most preferably in a range of about 1% to about 10% by weight of the disinfecting composition.

To provide increased stability and to further provide a desired viscosity, the disinfecting compositions of the invention may optionally comprise humectants and stabilizing agents, examples of which, include, but are not limited to, polyethylene glycol (e.g., PEG 600), other polyols such as glycerin, propylene, polypropylene glycol, sorbitol, and other hydrophilic polymers. The stabilizing agent may be included in an amount in a range from about 0% to about 70% by weight of the dental composition, preferably in a range from about 0.1% to about 30% by weight, more preferably in a range from about 1% to about 15% by weight of the disinfecting composition.

Sodium hypochlorite is typically more stable with rising pH. Accordingly, it may be desirable to include a mild or strong base or other pH adjuster in order to adjust the pH of the disinfecting compositions of the invention. Examples of suitable bases include, but are not limited to, alkali metal hydroxides (e.g., sodium or potassium hydroxide), other hydroxides, and amines (e.g., triethanolamine). The base or other pH adjuster is preferably included in an amount so as to maintain a desired level of stability of the sodium hypochlorite, while maintaining a desired level of gel stability, which may diminish as the pH is raised. In view of the tradeoff between sodium hypochlorite stability, which generally increases as the pH is raises, and gel stability, which generally decreases with rising pH, the pH of the disinfecting compositions may fall within a broad range of about 6 to about 13, preferably in a range of about 8 to about 12.5, more preferably in a range of about 10 to about 12, and most preferably in a range of about 11 to about 11.5.

The viscous disinfecting sodium hypochlorite compositions according to the invention may be stable one-part compositions formulated to have a shelf life of a few hours, days, weeks, or months, or they may be two-part compositions that are mixed up chair-side by the dentist just prior to application. Whether or not a composition is “stable” has two components. One aspect is the stability of the sodium hypochlorite, which tends to become less stable with lowering pH. Another aspect is the stability of the gelling agent, which tends to become less stable with rising pH. Sodium hypochlorite solutions are most stable when at a pH of about 11 or greater. On the other hand, fumed silica tends to dissolve at a pH above about 11.5. For this reason, the most preferred pH range is presently 11 to about 11.5, since fumed silica is presently the most preferred thickening or gelling agent.

It should also be appreciated that the disinfecting compositions of the invention may comprise additional components that have not been described but which are well known in the art. An example are flavoring oils, which can be used to minimize potential agitation to the patient if the disinfecting compositions of the invention happen to come in contact with the patient's oral tissues. Another example are chelating agents (e.g., EDTA).

In order to more fully illustrate disinfecting compositions according to the invention, the following examples are presented. All percentages are expressed in terms of weight percent unless otherwise specified. The sodium hypochlorite is in the form of an aqueous solution unless otherwise specified.

### EXAMPLE 1

A disinfecting composition was made from the following components:

| | | |
|---|---|---|
| Sodium Hypochlorite (5%) | 401.13 g | 54.83% |
| Water | 326.87 g | 44.68% |
| Xanthan Gum | 3.64 g | 0.50% |

The foregoing composition was vigorously blended and homogenized for five minutes and had a final sodium hypochlorite concentration of approximately 2.7% by weight of the final mixed composition. This composition was found to be too runny, probably the result of the xanthan gum being unstable in the presence of sodium hypochlorite. That xanthan gum is unstable in the presence of sodium hypochlorite appears to have been confirmed when an additional 3.64 g of xanthan gum was added but the resulting composition still did not have adequate stickiness and viscosity.

### EXAMPLE 2

A viscous disinfecting composition was made from the following components:

| | | |
|---|---|---|
| Sodium Hypochlorite (5%) | 401.13 g | 54.83% |
| Water | 326.87 g | 44.68% |
| Fumed Silica | 3.64 g | 0.50% |

The foregoing composition had a final sodium hypochlorite concentration of approximately 2.7% by weight of the final mixed composition. This composition had significantly increased viscosity and stickiness compared to a purely aqueous disinfecting solution, as well as the composition of Example 1. To the foregoing composition was added an additional 18.2 g of fumed silica, which resulted in even higher viscosity and stickiness, which thus demonstrated that fumed silica forms a stable gelling system in the presence of a sodium hypochlorite solution.

### EXAMPLE 3

A viscous disinfecting composition was made from the following components:

| | | | |
|---|---|---|---|
| Sodium Hypochlorite (5%) | 401.13 | g | 53.50% |
| Water | 326.87 | g | 43.59% |
| Fumed Silica | 21.84 | | 2.91% |

The foregoing components were homogenized for 3-4 minutes, thereby yielding a composition having increased viscosity and stickiness compared to the composition of Example 3.

### EXAMPLE 4

A viscous disinfecting composition was made from the following components:

| | | |
|---|---|---|
| Sodium Hypochlorite (5%) | 165.3 g | 55.1% |
| Water | 125.7 g | 41.9% |
| Fumed Silica | 9 g | 3% |

The foregoing components were homogenized for 3-4 minutes, thereby yielding a composition having increased viscosity and stickiness compared to the composition of Example 3.

### EXAMPLE 5

A viscous disinfecting composition was made from the following components:

| | | |
|---|---|---|
| Sodium Hypochlorite (5%) | 165.3 g | 55.1% |
| Polyethylene Glycol 600 | 6.0 g | 2% |
| Water | 119.7 g | 39.9% |
| Fumed Silica | 9 g | 3% |

The foregoing composition had excellent viscosity and stickiness properties, and also did not separate over time as a result of including PEG 600.

### EXAMPLE 6

A viscous disinfecting composition was made from the following components:

| | |
|---|---|
| Sodium Hypochlorite (5%) | 53.2% |
| Water | 41% |
| Carbopol 974 | 4.5% |
| Potassium Hydroxide | 1.3% |

The sodium hypochlorite and water were first blended. Thereafter, the Carbopol 974 and potassium hydroxide were added at the same time. The ingredients were mixed with an impeller until the powder is wet. Thereafter, the mixture was vacuum mixed until smooth. The pH of the resulting composition was 6.2

The foregoing composition had excellent viscosity and stickiness properties, but the sodium hypochlorite did not have long-term stability (i.e., it decomposed within a few weeks). Accordingly, the foregoing composition is most suited as a two-part composition.

### EXAMPLE 7

The composition of Example 7 was spiked with additional potassium hydroxide in order to yield a composition having 3.1% by weight potassium hydroxide and a pH of 13.0. The resulting composition has excellent viscosity and stickiness properties for a short period of time, but the Carbopol 974 lost viscosity over time as a result of the high pH. The sodium hypochlorite was stable over time.

### EXAMPLE 8

A viscous disinfecting composition was made from the following components:

| | | |
|---|---|---|
| Sodium Hypochlorite (5%) | 159.6 g | 53.2% |
| Water | 110.1 g | 36.7% |
| Carbopol 974 | 16.5 g | 5.5% |
| Potassium Hydroxide | 13.8 g | 4.5% |

The sodium hypochlorite and water were first blended. Thereafter, the Carbopol 974 and potassium hydroxide were added at the same time. The ingredients were mixed with an impeller until the powder is wet. Thereafter, the mixture was vacuum mixed until smooth. The pH of the resulting composition was 12.78.

### EXAMPLE 9

A viscous disinfecting composition was made from the following components:

| | | |
|---|---|---|
| Sodium Hypochlorite (5%) | 159.6 g | 53.2% |
| Water | 115.7 g | 38.4% |
| Carbopol 974 | 13.5 g | 4.5% |
| Potassium Hydroxide | 11 g | 3.9% |

The sodium hypochlorite and water were first blended. Thereafter, the Carbopol 974 and potassium hydroxide were added at the same time. The ingredients were mixed with an impeller until the powder is wet. Thereafter, the mixture was vacuum mixed until smooth. The pH of the resulting composition was 12.35.

### EXAMPLE 10

A viscous disinfecting composition was made from the following components:

| | | |
|---|---|---|
| Sodium Hypochlorite (5%) | 165 g | 55% |
| Water | 119.4 g | 39.8% |
| Carbopol 974 | 9 g | 3% |
| Potassium Hydroxide | 7.1 g | 2.34% |

The sodium hypochlorite and water were first blended. Thereafter, the Carbopol 974 and potassium hydroxide were added at the same time. The ingredients were mixed with an impeller until the powder is wet. Thereafter, the mixture was vacuum mixed until smooth. The pH of the resulting composition was 12.18.

### EXAMPLE 11

A viscous disinfecting composition was made from the following components:

| | | |
|---|---|---|
| Sodium Hypochlorite (5%) | 165 g | 55% |
| Water | 119.1 g | 39.7% |
| Carbopol 974 | 9 g | 3% |
| Potassium Hydroxide | 6.9 g | 2.3% |

The sodium hypochlorite and water were first blended. Thereafter, the Carbopol 974 and potassium hydroxide were added at the same time. The ingredients were mixed with an impeller until the powder is wet. Thereafter, the mixture was vacuum mixed until smooth. The pH of the resulting composition was 11.15.

### EXAMPLE 12

A viscous disinfecting composition was made from the following components:

| | | |
|---|---|---|
| Sodium Hypochlorite (5%) | 180 g | 60% |
| Water | 87 g | 29% |
| Sodium Hydroxide (50%) | 3 g | 1% |
| Fumed Aluminum Oxide | 30 g | 10% |

The pH of the resulting composition was 12.34.

### EXAMPLE 13

A viscous disinfecting composition was made from the following components:

| | |
|---|---|
| Sodium Hypochlorite (5%) | 60% |
| Water | 34.8% |
| Sodium Hydroxide (50%) | 1% |
| Aerosil R816 | 4% |
| PEG 600 | 0.2% |

### EXAMPLE 14

A viscous disinfecting composition was made from the following components:

| | |
|---|---|
| Sodium Hypochlorite (5%) | 60% |
| Water | 31% |
| Sodium Hydroxide (50%) | 1% |
| Titanium Dioxide P25 | 8% |

### EXAMPLE 15

A viscous disinfecting composition was made from the following components:

| | |
|---|---|
| Sodium Hypochlorite (5%) | 60% |
| Water | 33% |
| Sodium Hydroxide (50%) | 1% |
| Fumed Aluminum Oxide | 5% |
| Aerosil R816 | 1% |

### EXAMPLE 16

A viscous disinfecting composition was made from the following components:

| | |
|---|---|
| Sodium Hypochlorite (5%) | 60% |
| Water | 31% |
| Sodium Hydroxide (50%) | 1% |
| Fumed Aluminum Oxide | 8% |

### EXAMPLE 17

A viscous disinfecting composition was made from the following components:

| | |
|---|---|
| Sodium Hypochlorite (5%) | 60% |
| Water | 36% |
| PEG 600 | 0.5% |
| Cabosil M-5 | 3% |
| Sodium Hydroxide (50%) | 0.5% |

### EXAMPLE 18

A viscous disinfecting composition was made from the following components:

| | |
|---|---|
| Sodium Hypochlorite (5%) | 60% |
| Water | 36.6% |
| PEG 600 | 0.2% |
| Cabosil M-5 | 3% |
| Sodium Hydroxide (50%) | 0.2% |

2. Endodontic Use of Viscous Disinfecting Compositions

According to the presently preferred embodiment, the viscous disinfecting compositions of the invention, as described above, are used for disinfecting and sterilizing a root canal during an endodontic procedure.

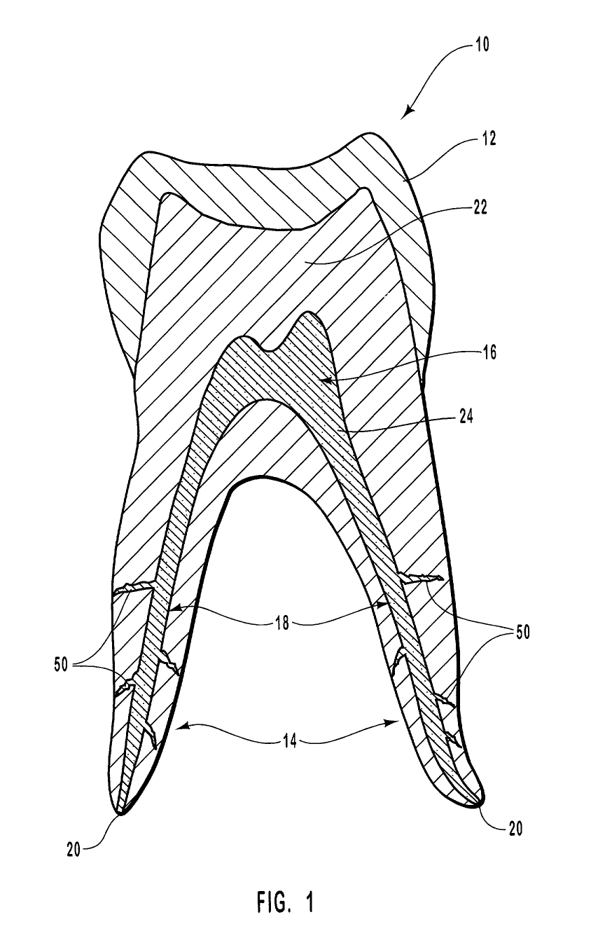

FIG. 1 illustrates a cross-sectional side view of a tooth 10. As shown, the tooth 10 has a crown 12 and two roots 14. The crown 12 is made of highly mineralized enamel and is generally exposed to the inside of the mouth. The roots 14 are not exposed, but rather are embedded within the gingivae (e.g., gums) and underlying bone tissue, which are not shown. The tooth 10 also comprises a pulp chamber 16, and one or more root canals 18. Each of the root canals 18 extends from the pulp chamber 16 to an apex 20 where the root canals communicate with the mandibular canal (not shown). The body of the tooth 10 comprises dentin 22, a bone-like material that supports the enamel crown 12.

The pulp chamber 16 and each of the root canals 18 is filled with pulp 24, which generally comprises vascular tissue composed of nerve fibers and blood vessels that are essential to the nourishment of the tooth 10 during its growth, development and long-term health. When bacteria gains access to the pulp 24, the pulp 24 can become infected and die unless the body is able to repair and heal the pulp 24. When the pulp 24 becomes so severely infected or otherwise damaged that it cannot be healed, it may be necessary to remove the pulp 24. One method for removing the pulp 24 is by way of an endodontic procedure commonly known as a root canal.

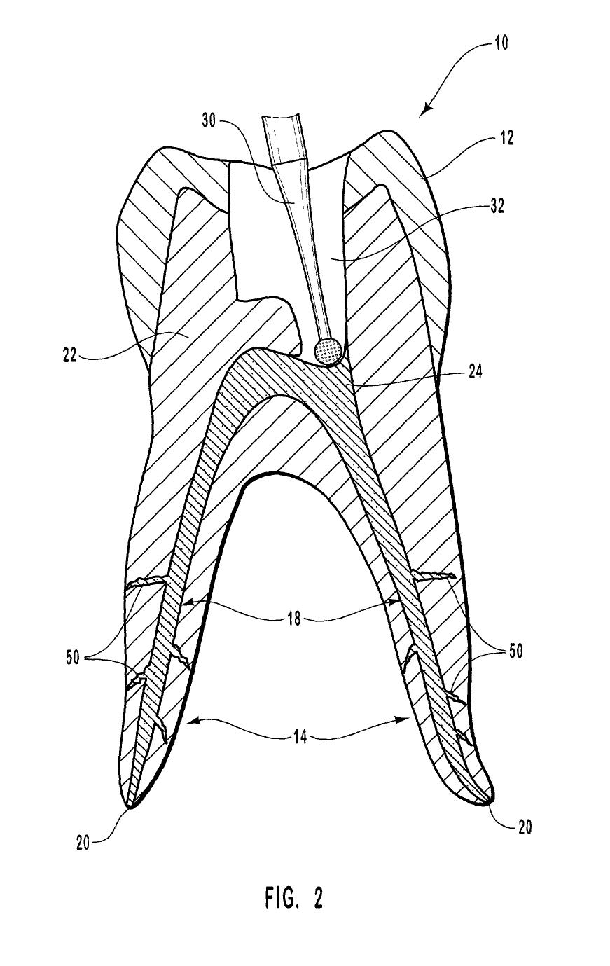

In order to perform a root canal, the endodontist typically drills through the crown 12 of the tooth 10 to access the pulp chamber 16 and root canal 18. This is illustrated in FIG. 2. As shown, a drill 30 is shown cutting a hole 32 through the crown 12 and dentin 22 so as to expose the pulp chamber 16. The dentist continues to cut away the crown 12 and dentin 22 until both of the root canals 18 can be accessed through the hole 32 that is being formed. Once access to the root canals 18 is adequate, the endodontist uses an endodontic tool to clean out and shape the root canals 18.

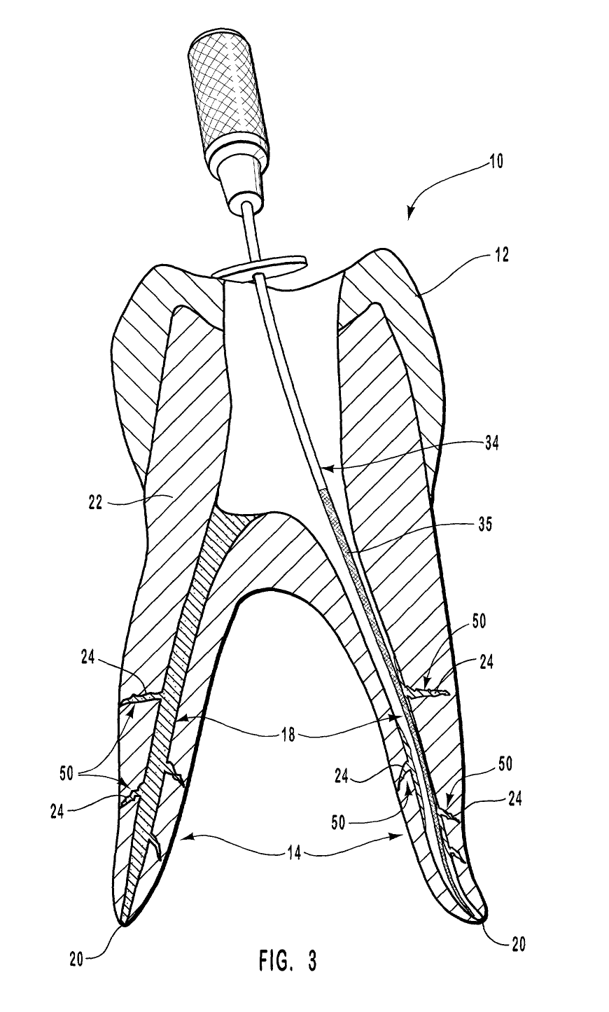

FIG. 3 illustrates one embodiment in which an endodontic tool 34 is being used to clean out and shape the root canal 18. The endodontic tool 34 generally includes an abrading surface 35, which can be used to loosen the contaminated pulp 24 and widen the root canal 18 so that it can be subsequently filled with a filling material. A more complete description of endodontic tools that are suitable for cleaning and shaping root canals is provided in U.S. Pat. No. 6,045,362, entitled “Endodontic Methods for Progressively, Sectionally and Anatomically Preparing Root Canals with Specific Instruments for Each Section Having Predetermined Working Lengths,” issued Jan. 28, 1998 to Riitano, and U.S. Pat. No. 6,059,572, entitled “Endodontic Methods for the Anatomical, Sectional and Progressive Corono-Apical Preparation of Root Canals with Three Sets of Dedicated Instruments,” issued Jun. 3, 1999 to Riitano. For purposes of disclosing endodontic tools and procedures, the foregoing patents are incorporated herein by reference.

During the endodontic procedure of cleaning and shaping the root canal 18, irrigants may be used to flush the pulp 24 and other loosened dental tissue out of the root canal 18. Suitable irrigants include, but are not limited to water, saline solutions, non-viscous aqueous sodium hypochlorite solutions, aqueous hydrogen peroxide, and other peroxide solutions.

Once the root canal 18 has been cleaned and shaped, a viscous disinfectant according to the invention is introduced into the root canal 18 to kill any remaining bacteria and to generally sanitize the root canal 18. One problem with existing disinfectants, however, is that they are typically in the form of an aqueous irrigant and can be, therefore, inherently difficult to control when applying. This is particularly true when the root canal 18 is located on an upper tooth because gravity can cause the disinfectants to flow out from the root canal. The present invention overcomes at least these problems by providing a viscous disinfecting composition that is capable of better adhering to the walls of the root canal 18.

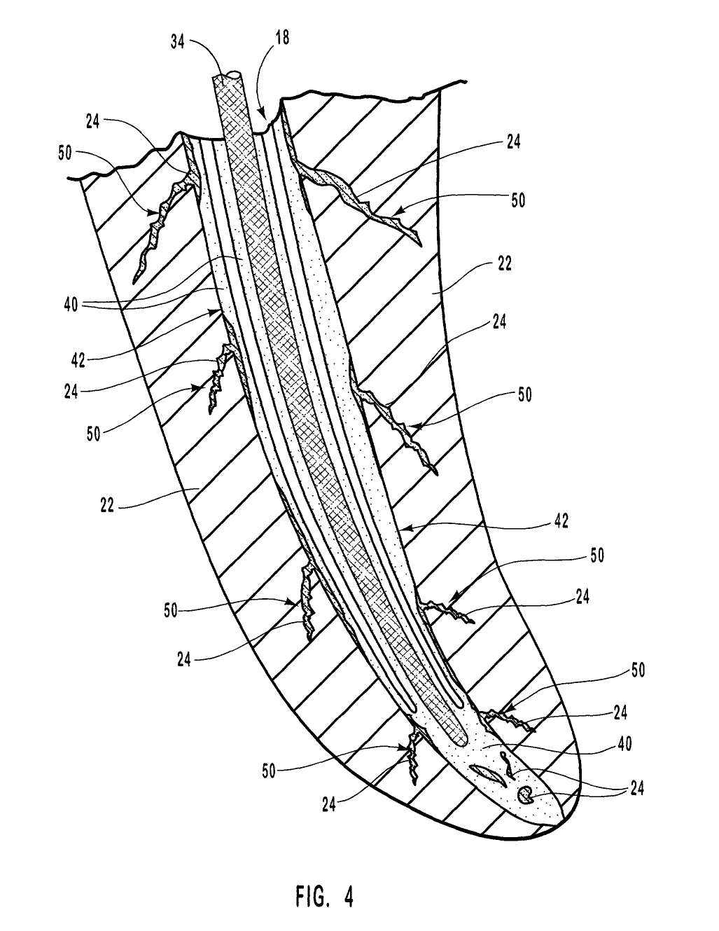

As shown in FIG. 4, once a viscous disinfecting composition 40 of the present invention is introduced into the root canal 18, it readily adheres to the walls or sides 42 of the root canal 18. This generally enables the viscous disinfecting composition 40 to disinfect and sanitize the root canal 18 so that it can be filled and sealed. The viscous disinfecting composition 40 may be introduced into the root canal 18 using any suitable means, such as with the endodontic tool 34 used to clean and shape the root canal 18. A hydraulic syringe is another suitable means for introducing the viscous disinfecting composition 40 into the root canal 18. Although the viscous disinfecting composition 40 may be introduced after cleaning and shaping of the root canal 18, it should be appreciated that the viscous disinfecting composition 40 can also be introduced before or during the step of cleaning and shaping of the root canal 18.

As shown in FIG. 4, the root canal 18 may comprise accessory canals 50 that extend into the dentin 22 of the root 14 and may contain pulp particles 24. The root canal 18 also comprises numerous microscopic tubules (not shown) that extend into the dentin 22 of the root 14. When pulp 24 becomes infected with bacteria, the bacteria can also be found in the accessory canals 50 and microscopic tubules. Accordingly, even after cleaning and shaping the root canal 18, infected pulp 24 and bacteria may still reside inside of the root canal 18.

Existing aqueous disinfectants and irrigants are sometimes used for disinfecting root canals. However, they are unable to adequately adhere to the walls 42 of the root canal 18, making it difficult to maintain contact with the walls 42 of the root canal 18 long enough to penetrate all of the accessory canals 50 and to chelate and dissolve the bacteria and pulp particles 24 in the accessory canals 50 and microscopic tubules.

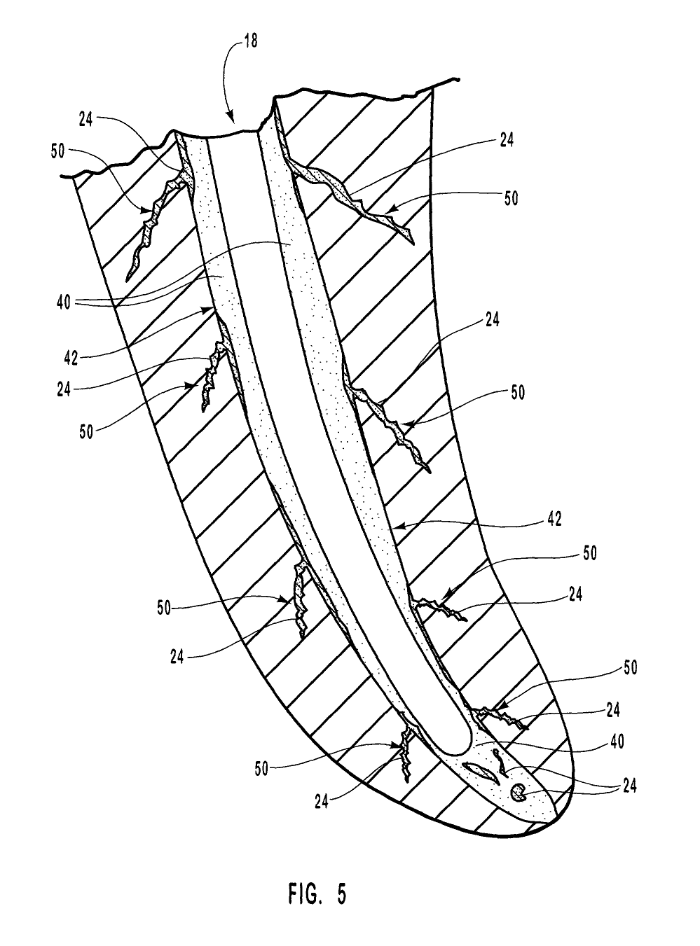

As shown in FIG. 5, the viscous disinfecting composition 40 of the present invention is able to adhere to the walls 42 of the root canal 18 without assistance, and is therefore able to maintain contact with the walls 42 of the root canal 18 for a sufficient period of time for the sodium hypochlorite or other disinfecting agent to penetrate the accessory canals 50 and to dissolve or chelate the pulp particles 24 that are found in the accessory canals 50 and that remain on the walls 42 of the root canal 18. According to one preferred embodiment, the viscous disinfecting composition 40 is left in contact with the surfaces of the root canal 18 for a period of time in a range of about 1 minute to about 1 hour.

It should be appreciated that by maintaining contact with the entire surface of the root canal, the disinfecting compositions of the invention are able to maximize their ability to neutralize and kill as much of the bacteria as is possible out of the root canal, accessory canals, and microscopic tubules, and is therefore able to minimize the possibility of future contamination within the root canal. Increased contact provides for enhanced chelating of pulp tissue.

It should also be appreciated that the viscosity of the disinfecting composition of the present invention generally enables application of the disinfecting composition in a controlled manner, so as to minimize the possibility of the disinfectant flowing into unintended areas of the patient's mouth. It should further be appreciated that this is an improvement over the prior art.

Once the viscous disinfecting composition has been applied to the surfaces of the root canal for a desired period of time, irrigants can be used to flush the disinfecting composition and any pulp particles out of the root canal. Irrigants can also be used at any time during the endodontic procedure to flush out pulp particles.

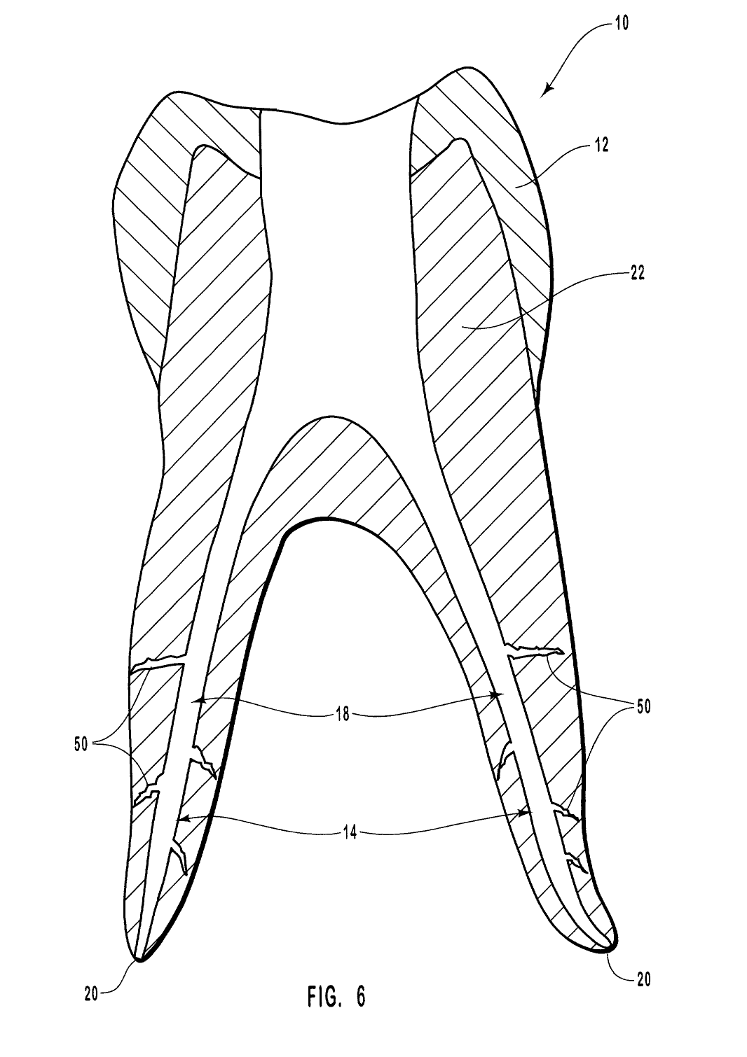

FIG. 6 illustrates the tooth 10 of FIG. 1 after it has been cleaned and disinfected according to the invention. As shown, the pulp particles 24 have been completely cleaned out of the root canals 18 and accessory canals 50, thereby minimizing the possibility of future infection in the root canals 18. It should be appreciated that even when the anatomy of the root canals 18 and accessory root canals 50 makes it impossible to completely clean out all of the pulp particles 24 from the root canals 18 and accessory canals 50, the present invention provides methods for maximizing the ability of the disinfecting compositions to disinfect and sanitize the root canal 18 and accessory canals 50. As a matter of illustration, and not limitation, once the root canals 18 are cleaned and disinfected, they can be filled with a filling material, such as gutta percha, an amalgam, or a curable resin, and then sealed with a sealer cement, such as any curable resin or composite known in the art, to prevent future contamination of the root canals 18.

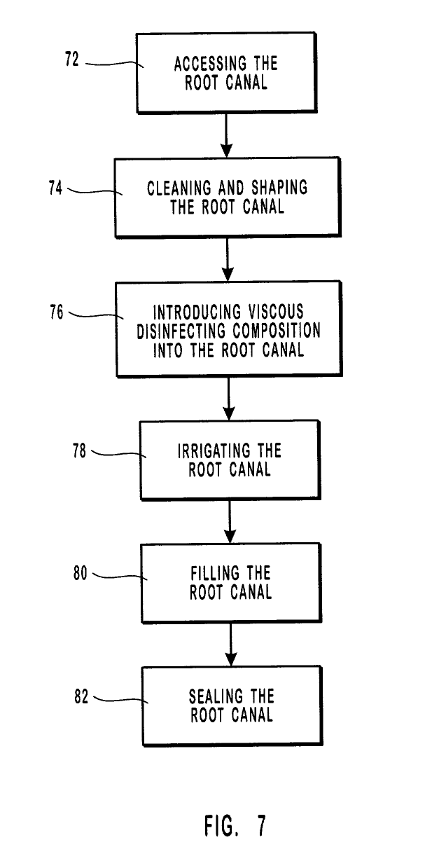

FIG. 7 illustrates a flow diagram of one suitable embodiment of the method of the invention, as it has been described, for using viscous disinfecting compositions to disinfect a root canal during an endodontic procedure. As shown, the first step is to access the root canal, step 72. This can be accomplished, as described above in reference to FIG. 2, by drilling through the crown and dentin of the tooth. Next, in step 74, the root canal is cleaned with an endodontic tool, as described above in reference to FIG. 3. Step 74 also involves the act of shaping the root canal so that a filling material can be placed into the root canal. Next, in step 76, the viscous disinfecting composition of the invention is introduced into the root canal. The viscous properties of the disinfecting composition cause the composition to adhere to the walls of the root canal so that it can effectively disinfect and sanitize the root canal, including the accessory canals, as described above in reference to FIGS. 4-6. After a predetermined period of time, the disinfecting composition and any remaining pulp particles are flushed out of the root canal with an irrigant, step 78. It should be appreciated, however, that both disinfecting step 76 and irrigating step 78 may be performed during the root canal procedure. The root canal is finally filled, in step 80, with a filling material and sealed, in step 82, with a sealant.

It should be appreciated that when viscous disinfecting compositions are used according to the methods of the invention, as described above, it is generally possible to increase the likelihood of success of the endodontic procedure by minimizing the amount of bacteria that will remain in the root canal.

The viscous properties of the disinfecting compositions of the invention are particularly beneficial for enabling the sodium hypochlorite or other disinfectant to maintain contact with the walls of the root canal, thereby maximizing the disinfectant's ability to disinfect and sanitize the root canal, accessory canals, and microscopic tubules. It should also be appreciated that this is an advance over the prior art in which existing disinfectants are applied in an aqueous form and are not capable of adhering to the walls of the root canal. It should further be appreciated that the present invention enables the viscous disinfecting compositions to be applied in a controlled manner, which is particularly beneficial when the root canal is located in an upper tooth, and which is an improvement over the prior art disinfectants that that freely flow out of an upper root canal under the influence of gravity.

The present invention may be embodied in other forms without departing from its spirit or essential characteristics. As properly understood, the preceding description of specific embodiments is illustrative only and in no way restrictive. The scope of the invention is, therefore, indicated by the appended claims as follows.

What is claimed and desired to be secured by United States Letters Patent is:

1. A method for disinfecting a root canal during an endodontic procedure, comprising:
providing access to a root canal of a tooth; and
introducing a viscous disinfecting composition into the root canal, wherein said viscous disinfecting composition is able to adhere to walls of the root canal so as to enable the disinfecting composition to disinfect the root canal.

2. A method as defined in claim 1, wherein said viscous disinfecting composition comprises sodium hypochlorite, water, and a gelling agent.

3. A method as defined in claim 2, wherein the gelling agent comprises at least one finely divided particulate gelling agent.

4. A method as defined in claim 3, wherein the finely divided particulate gelling agent comprises at least one of fumed silica or fumed aluminum oxide.

5. A method as defined in claim 2, wherein the gelling agent comprises at least one polymeric gelling agent.

6. A method as defined in claim 5, wherein the gelling agent comprises carboxypolymethylene.

7. A method as defined in claim 2, wherein the sodium hypochlorite is included in a range of about 0.01% to about 50% by weight of the viscous disinfecting composition.

8. A method as defined in claim 2, wherein the sodium hypochlorite is included in a range of about 0.1% to about 40% by weight of the viscous disinfecting composition.

9. A method as defined in claim 2, wherein the sodium hypochlorite is included in a range of about 1% to about 20% by weight of the viscous disinfecting composition.

10. A method as defined in claim 2, wherein the sodium hypochlorite is included in a range of about 2% to about 10% by weight of the viscous disinfecting composition.

11. A method as defined in claim 1, further comprising:
cleaning at least a part of the root canal with an endodontic tool; and
irrigating the root canal to remove the viscous disinfecting composition and any loosened pulp or other debris.

12. A method as defined in claim 11, wherein the endodontic tool comprises an endodontic file and wherein the viscous disinfecting composition is introduced into the root canal by means of the endodontic file.

13. A method as defined in claim 1, wherein the viscous disinfecting composition is left in the root canal for a time in a range of about 1 minute to about 1 hour.

14. A method as defined in claim 1, wherein the viscous disinfecting composition has a viscosity in a range from about 500 cps to about 200,000 cps.

15. A method as defined in claim 1, wherein the viscous disinfecting composition has a viscosity in a range from about 5,000 cps to about 100,000 cps.

16. A method as defined in claim 1, wherein the viscous disinfecting composition has a viscosity in a range from about 10,000 cps to about 50,000 cps.

17. A method as defined in claim 1, wherein the viscous disinfecting composition has a pH in a range from about 8 to about 12.5.

18. A method as defined in claim 1, wherein the viscous disinfecting composition has a pH in a range from about 10 to about 12.

19. A method as defined in claim 1, wherein the viscous disinfecting composition has a pH in a range from about 11 to about 11.5.

20. A method for disinfecting a root canal during an endodontic procedure, comprising:
providing access to a root canal of a tooth; and
introducing a viscous disinfecting composition into the root canal comprising sodium hypochlorite, water, and a gelling agent.

21. A method as defined in claim 17, wherein the gelling agent comprises fumed silica.

22. A method as defined in claim 17, wherein the viscous disinfecting composition has a pH in a range of about 10 to about 12.

23. A method as defined in claim 17, wherein the viscous disinfecting composition has a pH in a range of about 11 to about 11.5.

24. A method as defined in claim 17, further comprising:
cleaning at least a part of the root canal with an endodontic tool; and
irrigating the root canal to remove the viscous disinfecting composition and any loosened pulp or other debris.

25. A method for disinfecting a root canal during an endodontic procedure comprising:
providing access to a root canal of a tooth; and
introducing a viscous disinfecting composition into the root canal comprising sodium hypochlorite in an amount in a range of about 1% to about 20% by weight, water, and fumed silica in an amount in a range of about 1% to about 10% by weight.

26. A method as defined in claim 25, wherein the viscous disinfecting composition further includes a base in an amount so that the pH of the composition is in a range of about 10 to about 12.

27. A method as defined in claim 25, wherein the viscous disinfecting composition further includes a base in an amount so that the pH of the composition is in a range of about 11 to about 11.5.
